(19) United States
(12) Patent Application Publication
(10) Pub. No.: US 2003/0111195 A1
(43) Pub. Date: Jun. 19, 2003

(54) Method and system for manufacturing tissue products, and products produced thereby

(75) Inventor: Sheng-hsin Hu, Appleton, WI (US)

Correspondence Address: John E. Vick, Jr., Dority & Manning, Attorneys at Law, P.A., P.O. Box 1449, Greenville, SC, 29602, US

(73) Assignee: Kimberly-Clark Worldwide, Inc.

(21) Appl. No.: 10/025,383

(22) Filed: Dec. 19, 2001

(51) Int. Cl. B31F 1/12; D21H 27/30

(52) U.S. Cl. 162/111; 162/123

(57) ABSTRACT

A process and product of making an absorbent paper article such as paper products, towels, and napkins from a paper web is disclosed. A process for making a product having superior properties of softness, handfeel, and strength is shown. The product may exhibit reduced sloughing, that is, a reduction in the amount of paper particles or flakes generated from the product upon abrasion of the product. A furnish that uses refined fibers may be employed. Furthermore, it is sometimes advantageous to use a closed pocket creping angle when creping the paper web from the surface of a rotating dryer.

### BACKGROUND OF THE INVENTION

Strength and softness are important attributes in consumer products such as bathroom tissue, towels, and napkins. Strength and softness are strongly influenced by the sheet structure of a paper product. The mechanical treatment of fibers employed in the manufacture of paper products is an important factor in determining the strength and softness of products made from such fibers.

Strength and softness usually are inversely related. That is, the stronger a given sheet, the less softness that sheet is likely to provide. Likewise, a softer sheet is usually not as strong. Thus, this inverse relationship between strength and softness results in a constant endeavor in the industry to produce a sheet having a strength, which is at least as great as conventional sheets, but with improved softness. Also, a sheet that is at least as soft as known sheets, but with improved strength, also is desirable.

It is common in the manufacture of paper products to “crepe” the paper web by scraping the paper web from the surface of a heated dryer. Wet paper is applied to the dryer (sometimes called a Yankee dryer) with adhesive. A blade, sometimes known as a doctor blade, then may be used to remove the dried paper from the dryer surface. The blade usually is held against the surface of the rotating dryer at an angle.

The creping pocket, or pocket angle, is formed by the contact angle between the dryer and the surface of the doctor blade against which the paper web impacts. In general, using a lower angle causes more energy to be transferred to the tissue as it leaves the dryer surface. However, the increased energy will sometimes cause a failure at the web/adhesive interface resulting in folding of the sheet (as demonstrated by a coarse crepe) rather than compressive debonding which would yield a less dense and softer sheet.

As a general rule fibers having better softness are provided in outer layers of paper products—which routinely contact the skin of consumers. The inner layers of such paper products often comprise coarse fibers which are less desirable in their properties of softness, absorbency, or strength.

Sloughing of paper products, such as bath tissue, may be an important factor in tissue manufacture. Sloughing may be described generally as the loss of paper particles from the surface of the paper due to surface abrasion. Sloughing is undesirable. Unfortunately, sloughing sometimes is increased by the use of debonding agents. Debonding agents are used to soften paper products. Many consumers react negatively to paper that exhibits a high degree of sloughing. Therefore, efforts are made to provide a paper product that exhibits a minimal amount of sloughing.

It would be desirable to provide a process, system and resulting product showing capable of providing a high degree of softness and strength, with reduced amounts of sloughing.

### SUMMARY OF THE INVENTION

In the invention, a method and system for manufacturing tissue products is provided. In the method, at least one papermaking furnish containing fibers is employed. Furthermore, a furnish is deposited upon a drying surface to form a paper web. Then, the drying surface is contacted with a creping blade, which is held against the drying surface at an angle of less than about 82%. In some applications, the paper web is combined with another paper web to form a multi-layered paper product, or tissue.

In some applications of the invention, it is desirable to use refined fibers. In other applications of the invention, the creping blade angle may be less than about 80%, or sometimes even less than about 78%.

### BRIEF DESCRIPTION OF THE DRAWINGS

A full and enabling disclosure of this invention, including the best mode shown to one of ordinary skill in the art, is set forth in this specification.

FIG. 1 is a schematic flow diagram of one embodiment of a papermaking process that can be used in the present invention; and

FIG. 2 is a schematic flow diagram of another embodiment of a papermaking process that can be used in the present invention; and

FIG. 3 is a schematic representation of the creping pocket, illustrating the creping geometry; and

FIG. 4 is a perspective view of a machine used to measure slough of a paper sample; and

FIG. 5 comprises data generated in Examples 1-6, described below.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention, which broader aspects are embodied in the exemplary constructions.

Surprisingly, it has been discovered that a closed pocket creping angle affects the characteristics of tissue in a positive way. This affect may be even more pronounced when refined fibers are employed. Now, it has been discovered that using refined fibers also may produce a superior paper product. A wide variety of cellulosic fibers may be employed in the process of the present invention. In many embodiments of the invention, a first furnish comprising a strength layer is employed. This first furnish may be a softwood, for example. The average fiber length of a softwood fiber typically is about two to four times longer than a hardwood fiber. Softwood sources include trees sources, such as pines, spruces, and firs and the like.

Hardwood sources such as oaks, eucalyptuses, poplars, beeches, and aspens, may be used, but this list is by no means exhaustive of all the hardwood sources that may be employed in the practice of the invention. Fibers from different sources of wood exhibit different properties. Hardwood fibers, for example, tend to show high degrees of “fuzziness” or softness when placed on the exterior surface of a paper product, such as a bathroom tissue.

Illustrative cellulosic fibers that may be employed in the practice of the invention include, but are not limited to, wood and wood products, such as wood pulp fibers; non-woody paper-making fibers from cotton, from straws and grasses, such as rice and esparto, from canes and reeds, such as bagasse, from bamboos, form stalks with bast fibers, such as jute, flax, kenaf, cannabis, linen and ramie, and from leaf fibers, such as abaca and sisal. It is also possible to use mixtures of one or more cellulosic fibers.

As used herein, the term “fiber” or “fibrous” is meant to refer to a particulate material wherein the length to diameter ratio (aspect ratio) of such particulate material is greater than about 10. Conversely, a “nonfiber” or “nonfibrous” material is meant to refer to a particulate material wherein the length to diameter ratio of such particulate material is about 10 or less. It is generally desired that the cellulosic fibers used herein be wettable. Suitable cellulosic fibers include those which are naturally wettable. However, naturally non-wettable fibers can also be used.

In the practice of the present invention, it is desired that the cellulosic fibers be used in a form wherein the cellulosic fibers have already been prepared into a pulp. As such, the cellulosic fibers will be presented substantially in the form of individual cellulosic fibers, although such individual cellulosic fibers may be in an aggregate form such as a pulp sheet. This is in contrast with untreated cellulosic forms such as wood chips or the like. Thus, the current process is generally a post-pulping, cellulosic fiber separation process as compared to other processes that may be used for high-yield pulp manufacturing processes.

The preparation of cellulosic fibers from most cellulosic sources results in a heterogeneous mixture of cellulosic fibers. The individual cellulosic fibers in the mixture exhibit a broad spectrum of values for a variety of properties such as length, coarseness, diameter, curl, color, chemical modification, cell wall thickness, fiber flexibility, and hemicellulose and/or lignin content. As such, seemingly similar mixtures of cellulosic fibers prepared from the same cellulosic source may exhibit different mixture properties, such as freeness, water retention, and fines content because of the difference in actual cellulosic fiber make-up of each mixture or slurry.

In general, the cellulosic fibers may be used in the process of the present invention in either a dry or a wet state. However, it may be desirable to prepare an aqueous mixture comprising the cellulosic fibers wherein the aqueous mixture is agitated, stirred, or blended to effectively disperse the cellulosic fibers throughout the water.

The cellulosic fibers are typically mixed with an aqueous solution wherein the aqueous solution beneficially comprises at least about 30 weight percent water, suitably about 50 weight percent water, more suitably about 75 weight percent water, and most suitably about 100 weight percent water. When another liquid is employed with the water, such other suitable liquids include methanol, ethanol, isopropanol, and acetone. However, the use or presence of such other non-aqueous liquids may impede the formation of an essentially homogeneous mixture such that the cellulosic fibers do not effectively disperse into the aqueous solution and effectively or uniformly mix with the water. Such a mixture should generally be prepared under conditions that are sufficient for the cellulosic fibers and water to be effectively mixed together. Generally, such conditions will include using a temperature that is between about 10 degrees C. and about 100 degrees C.

In general, cellulosic fibers are prepared by pulping or other preparation processes in which the cellulosic fibers are present in an aqueous solution. The cellulosic fibers treated according to the process of the present invention are suited for use in disposable paper products such as facial or bathroom tissue, paper towels, wipes, napkins, and disposable paper products. Furthermore, other applications of the invention may be directed to products including: diapers, adult incontinent products, bed pads, sanitary napkins, tampons, other wipes, bibs, wound dressings, surgical capes or drapes.

### Papermaking Processes

A papermaking process can be utilized to form a multi-layered paper web, such as described and disclosed in U.S. Pat. No. 5,129,988 to Farrinqton, Jr.; U.S. Pat. No. 5,494,554 to Edwards, et al.; and U.S. Pat. No. 5,529,665 to Kaun, which are incorporated herein in their entirety by reference thereto for all purposes.

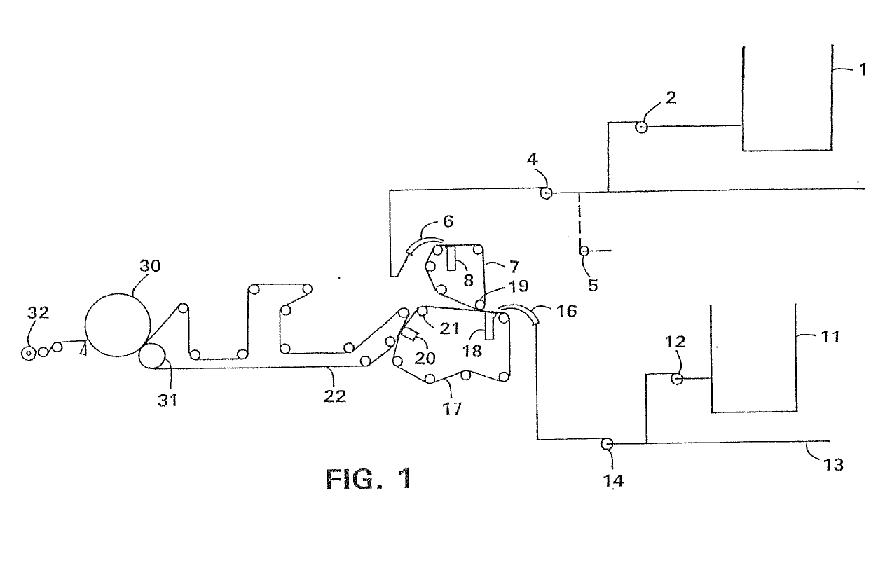

In this regard, various embodiments of a method for forming a multi-layered paper web will now be described in more detail. Referring to FIG. 1, a method of making a wet-pressed tissue in accordance with one embodiment of the present invention is shown, commonly referred to as couch forming, wherein two wet web layers are independently formed and thereafter combined into a unitary web. To form the first web layer, a specified fiber (either hardwood or softwood) is prepared in a manner well known in the papermaking arts and delivered to the first stock chest 1, in which the fiber is kept in an aqueous suspension. A stock pump 2 supplies the required amount of suspension to the suction side of the fan pump 4. If desired, a metering pump 5 can supply an additive (e.g., latex, reactive composition, etc.) into the fiber suspension. Additional dilution water also is mixed with the fiber suspension.

The entire mixture of fibers is then pressurized and delivered to the headbox 6. The aqueous suspension leaves the headbox 6 and is deposited on an endless papermaking fabric 7 over the suction box 8. The suction box is under vacuum that draws water out of the suspension, thus forming the first layer. In this example, the stock issuing from the headbox 6 would be referred to as the “air side” layer, that layer eventually being positioned away from the dryer surface during drying.

The forming fabric can be any forming fabric, such as fabrics having a fiber support index of about 150 or greater. Some suitable forming fabrics include, but are not limited to, single layer fabrics, such as the Appleton Wire 94M available from Albany International Corporation, Appleton Wire Division, Menasha, Wis.; double layer fabrics, such as the Asten 866 available from Asten Group, Appleton, Wis.; and triple layer fabrics, such as the Lindsay 3080, available from Lindsay Wire, Florence, Miss.

The consistency of the aqueous suspension of papermaking fibers leaving the headbox can be from about 0.05 to about 2%, and in one embodiment, about 0.2%. The first headbox 6 can be a layered headbox with two or more layering chambers which delivers a stratified first wet web layer, or it can be a monolayered headbox which delivers a blended or homogeneous first wet web layer.

To form the second web layer, a specified fiber (either hardwood or softwood) is prepared in a manner well known in the papermaking arts and delivered to the second stock chest 11, in which the fiber is kept in an aqueous suspension. A stock pump 12 supplies the required amount of suspension to the suction side of the fan pump 14. A metering pump 5 can supply additives (e.g., latex, reactive composition, etc.) into the fiber suspension as described above. Additional dilution water 13 is also mixed with the fiber suspension. The entire mixture is then pressurized and delivered to the headbox 16. The aqueous suspension leaves the headbox 16 and is deposited onto an endless papermaking fabric 17 over the suction box 18. The suction box is under vacuum which draws water out of the suspension, thus forming the second wet web. In this example, the stock issuing from the headbox 16 is referred to as the “dryer side” layer as that layer will be in eventual contact with the dryer surface. Suitable forming fabrics for the forming fabric 17 of the second headbox include those forming fabrics previously mentioned with respect to the first headbox forming fabric.

After initial formation of the first and second wet web layers, the two web layers are brought together in contacting relationship (couched) while at a consistency of from about 10 to about 30%. Whatever consistency is selected, it is typically desired that the consistencies of the two wet webs be substantially the same. Couching is achieved by bringing the first wet web layer into contact with the second wet web layer at roll 19.

After the consolidated web has been transferred to the felt 22 at vacuum box 20, dewatering, drying and creping of the consolidated web is achieved in the conventional manner. More specifically, the couched web is further dewatered and transferred to a dryer 30 (e.g., Yankee dryer) using a pressure roll 31, which serves to express water from the web, which is absorbed by the felt, and causes the web to adhere to the surface of the dryer. The web is then dried, optionally creped and wound into a roll 32 for subsequent converting into the final creped product.

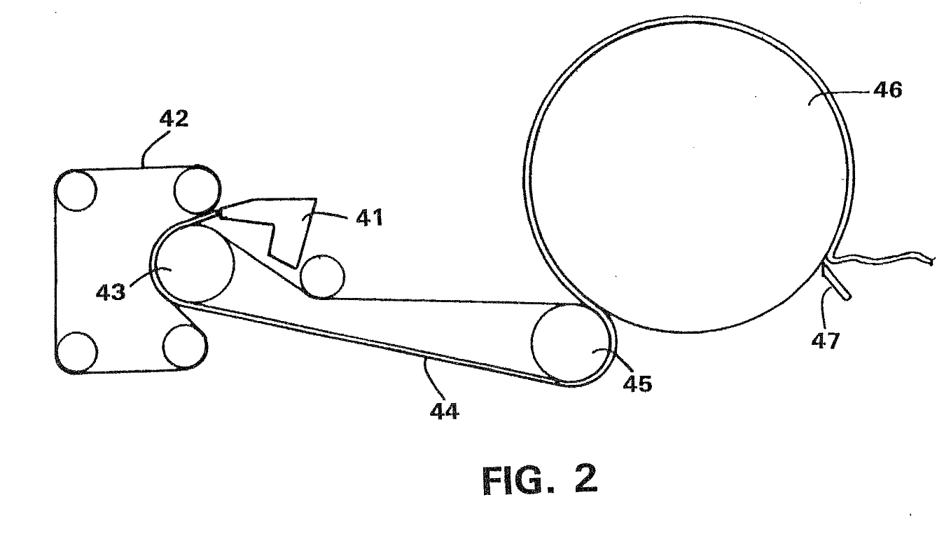

FIG. 2 is a schematic flow diagram of another embodiment of a papermaking process that can be used in the present invention. For instance, a layered headbox 41, a forming fabric 42, a forming roll 43, a papermaking felt 44, a press roll 45, a Yankee dryer 46, and a creping blade 47 are shown. Also shown, but not numbered, are various idler or tension rolls used for defining the fabric runs in the schematic diagram, which may differ in practice. In operation, a layered headbox 41 continuously deposits a layered stock jet between the forming fabric 42 and the felt 44, which is partially wrapped around the forming roll 43. Water is removed from the aqueous stock suspension through the forming fabric 42 by centrifugal force as the newly-formed web traverses the arc of the forming roll. As the forming fabric 42 and felt 44 separate, the wet web stays with the felt 44 and is transported to the Yankee dryer 46.

At the Yankee dryer 46, the creping chemicals are continuously applied on top of the existing adhesive in the form of an aqueous solution. The solution is applied by any convenient means, such as using a spray boom that evenly sprays the surface of the dryer with the creping adhesive solution. The point of application on the surface of the dryer 46 is immediately following the creping doctor blade 47, permitting sufficient time for the spreading and drying of the film of fresh adhesive.

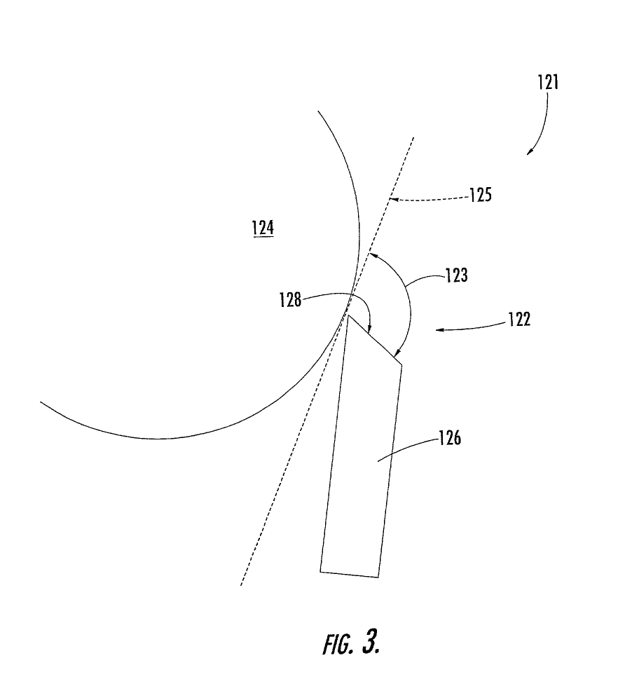

FIG. 3 is a schematic view illustrating a typical creping operation, showing the creping geometry 121. The creping pocket 122 forms a creping pocket angle 123. This creping pocket angle 123 is formed by the angle between a tangent line 125 to the Yankee dryer 124 at the point of contact with the creping blade 126, and the surface 128 of the creping blade 126 against which the sheet impacts.

The creping pocket angle 123 is schematically indicated by the double arrow in FIG. 3. The angle varies depending upon the particular paper product being formed, and may be adjusted to achieve certain desired results.

In general, lower angles cause more energy to be transferred to the paper web (not shown). However, the increased energy of a lowered creping pocket angle 123 sometimes causes a failure at the web/adhesive interface resulting in folding of the sheet (as demonstrated for example by a coarse crepe) rather than compressive debonding which would yield a less dense, softer product.

Unexpectedly, the adhesion derived from this invention allows the increased energy derived from closed pocket creping to result in a failure in the adhesive layer itself. This facilitates compressive debonding of the sheet, yielding a less dense and softer sheet.

The crepe that results from the application of the invention may provide a combination of both coarse and fine structures. The invention may employ a fine crepe structure superimposed upon an underlying coarse crepe structure. Thus, the fine structure confirms the effective break-up of the sheet while the underlying coarse structure enhances the perception of substance.

### Stiffness

Stiffness (or softness) was ranked on a scale from 0 (described as pliable/flexible) to 16 (described as stiff/rigid). Twelve (12) panelists were asked to consider the amount of pointed, rippled or cracked edges or peaks felt from the sample while turning in your hand. The panelists were instructed to place two tissue samples flat on a smooth tabletop. The tissue samples overlapped one another by 0.5 inches (1.27 centimeters) and were flipped so that opposite sides of the tissue samples were represented during testing. With forearms/elbows of each panelist resting on the table, they placed their open hand, palm down, on the samples. Each was instructed to position their hand so their fingers were pointing toward the top of the samples, approximately 1.5 inches (approximately 3.81 centimeters) from the edge. Each panelist moved their fingers toward their palm with little or no downward pressure to gather the tissue samples. They gently moved the gathered samples around in the palm of their hand approximately 2 to 3 turns. The rank assigned by each panelist for a given tissue sample was then averaged and recorded.

### Tensile (GMT) Strength Test Method

Tensile strength was reported as “GMT” (grams per 3 inches of a sample), which is the geometric mean tensile strength and is calculated as the square root of the product of MD tensile strength and CD tensile strength. MD and CD tensile strengths were determined using a MTS/Sintech tensile tester (available from the MTS Systems Corp., Eden Prairie, Minn.). Tissue samples measuring 3 inch wide were cut in both the machine and cross-machine directions. For each test, a sample strip was placed in the jaws of the tester, set at a 4 inch gauge length for facial tissue and 2 inch gauge length for bath tissue. The crosshead speed during the test was 10 in./minute. The tester was connected with a computer loaded with data acquisition system; e.g., MTS TestWork for windows software. Readings were taken directly from a computer screen readout at the point of rupture to obtain the tensile strength of an individual sample.

### Refining of Fiber

Refining or beating of chemical pulps is the mechanical treatment and modification of fibers so that they can be formed into paper or board having desirable properties. It is used when preparing papermaking fibers for high-quality papers or paperboards, and in the past has not been widely employed for bathroom tissue or similar soft paper products.

Refining improves the bonding ability of fibers so that they form a strong and smooth paper sheet with good printing properties. Sometimes refining shortens fibers that are too long for a good sheet formation, or to develop other pulp properties such as absorbency, porosity, or optical properties specifically for a given paper grade.

A common refining or beating method is to treat fibers in the presence of water with metallic bars. The plates or fillings are grooved so that the bars that treat fibers and the grooves between bars allow fiber transportation through the refining machine. Such machines are known in the papermaking art.

Most refining is performed during a stage when bar edges give mechanical treatment and friction between fibers gives fiber-to-fiber treatment inside the floc. This stage continues until the leading edges reach the tailing edges of the opposite bars. After the edge-to-surface stage, the fiber bundle (floc) is still pressed between the flat bar surfaces until the tailing edge of the rotor bar has passed the tailing edge of the stator bar.

The refining results to a great extent depends on the stapling of fibers on the bar edges and on the behavior of the fibers in the floc during refining impacts. Long-fibered softwood pulps easily get stapled on the bar edges and build strong flocs that do not easily break in refining. Decreased gap clearance hastens refining degree change and increases fiber cutting. On the contrary, it is usually more difficult to get short-fibered hardwood pulps stapled on the bar edges, and such hardwood fibers may build weak flocs that easily break in refining. Decreased gap clearance means slower refining, in general.

The common feature of low-consistency refining theories is that the total or gross applied refiner power is divided into two components. The net refining power, which is the fiber-treating component, is the total absorbed refiner power minus no load power or idling power. The no load power is measured with water flowing through the running refiner, and the gap clearance is as narrow as possible without fillings or plates touching each other or any substantial increase in power. Total power, of course, depends on the actual running situation. Often the refining resistance of fibers determines the maximum loadability, but the ultimate limit is set by the torque moment of the refiner. This torque-based maximum total power increases linearly as the rotation speed of the refiner increases.

The amount of refining is described by means of the net energy input or the amount of net energy transferred to fibers. It is a practical way to evaluating the conditions inside the refiner. Fibers employed in this invention were refined, as measured in terms of HPD/T (horsepower days per metric ton of dry fiber) as reported in Table 1, for example.

### Slough Measurement Methods and Apparatus

To determine the abrasion resistance or tendency of fibers to be rubbed from the web, samples were measured by abrading the tissue specimens by way of the following method. This test measures the resistance of tissue material to abrasive action when the material is subjected to a horizontally reciprocating surface abrader. All samples were conditioned at about 23° C. and about 50% relative humidity for a minimum of 4 hours.

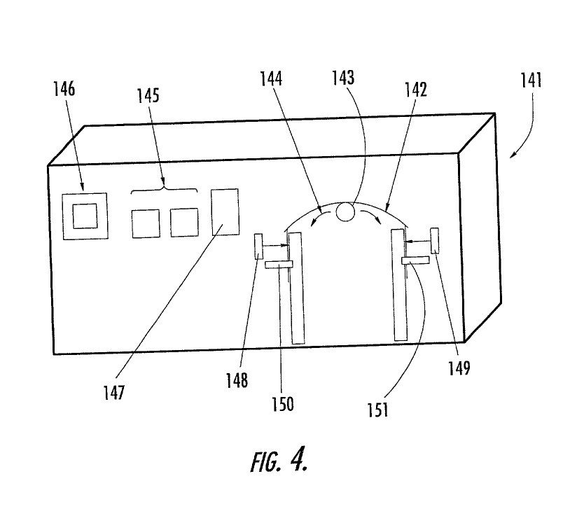

FIG. 4 shows a diagram of the test equipment that may be employed to abrade a sheet. In FIG. 3, a machine 141 having a mandrel 143 receives a tissue sample 142. A sliding magnetic clamp 148 with guide pins (not shown) is positioned opposite a stationary magnetic clamp 149, also having guide pins (150-151). A cycle speed control 147 is provided, with start/stop controls 145 located on the upper panel, near the upper left portion of FIG. 4. A counter 146 is shown on the left side of machine 141, which displays counts or cycles.

In FIG. 4, the mandrel 143 used for abrasion may consist of a stainless steel rod, about 0.5″ in diameter with the abrasive portion consisting of a 0.005″ deep diamond pattern extending 4.25″ in length around the entire circumference of the rod. The mandrel 143 is mounted perpendicular to the face of the machine 141 such that the abrasive portion of the mandrel 143 extends out from the front face of the machine 141. On each side of the mandrel 143 are located guide pins 150-151 for interaction with sliding magnetic clamp 148 and stationary magnetic clamp 149, respectively. These sliding magnetic clamp 148 and stationary magnetic clamp 149 are spaced about 4″ apart and centered about the mandrel 143. The sliding magnetic clamp 148 and stationary magnetic clamp 149 are configured to slide freely in the vertical direction.

Using a die press with a die cutter, specimens are cut into 3″ wide×8″ long strips with two holes at each end of the sample. For tissue samples, the Machine Direction (MD) corresponds to the longer dimension. Each test strip is weighed to the nearest 0.1 mg. Each end of the sample 142 is applied upon the guide pins 150-151 and sliding magnetic clamp 148 and stationary magnetic clamp 149 to hold the sample 142 in place.

The mandrel 143 is then moved back and forth at an approximate 15 degree angle from the centered vertical centerline in a reciprocal horizontal motion against the test strip for 20 cycles (each cycle is a back and forth stroke), at a speed of about 80 cycles per minute, removing loose fibers from the web surface. Additionally the spindle 143 rotates counter clockwise (when looking at the front of the instrument) at an approximate speed of 5 revolutions per minute (rpm). The sliding magnetic clamp 148 and stationary magnetic clamp 149 then are removed from the sample 142. Sample 142 is removed by blowing compressed air (approximately 5-10 psi) upon the sample 142.

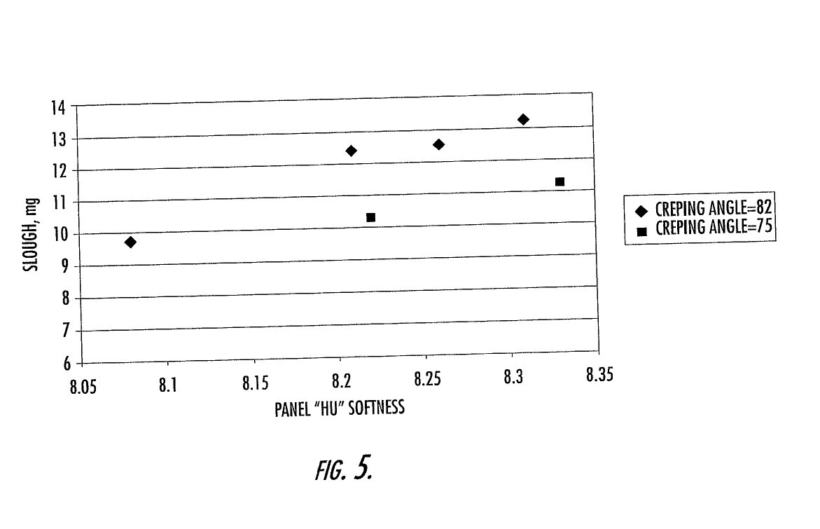

The sample 142 is weighed to the nearest 0.1 mg and the weight loss calculated. Ten test samples per tissue sample may be tested and the average weight loss value in milligrams is recorded. The result for each example was compared with a control sample containing no hairspray. Results are shown in FIG. 5, for control samples and for samples that have been treated according to the teachings of this invention.

Data from the following Examples 1-6 is shown in Table 1, and in graphic form in FIG. 6.

### EXAMPLE 1

### Control Sample Unrefined Fibers: Creping Pocket Angle of 82 Degrees

A soft tissue product to be used as control was made using a creping pocket angle of about 82 degrees, using unrefined fibers, as further described below. A layered headbox was employed. The first stock layer contained eucalyptus hardwood fiber which made up about 65% of the sheet by weight. This layer is the first layer to contact the forming fabric. Because it is transferred to a carrier felt, the hardwood layer also is the layer that contacts the drying surface. The second stock layer contained northern softwood fiber (designated LL-19). It comprised about 35% of the sheet by weight.

Permanent wet strength agent (Kymene, available from Hercules, Inc) was added in an amount equivalent to about 4 lbs/(about 0.2%) to the eucalyptus fiber and LL-19. The LL-19 fiber was not subjected to refining. A dry strength agent (Parez from Cytec) was added to the softwood side stock pump to adjust tensile strength. The machine speed of the 24-inch wide sheet was about 3000 feet per minute. The creping pocket angle was about 82 degrees. This tissue was piled together and calendered with two steel rolls at 30 pounds per lineal inch. This 2-ply product employed the dryer/softer eucalyptus layer plied to the outside of the product. The tissue was subjected to tensile test, slough test and panel softness evaluations.

### EXAMPLE 2

### Slightly Refined Fibers Creping Pocket Angle of 82 Degrees

Tissue sample was prepared as in Example 1 except that the LL-19 fiber fraction was subjected to refining with about 1.5 horsepower days per metric ton of dry fiber (HPD/T) energy input employed.

### EXAMPLE 3

### Moderately Refined Fibers Creping Pocket Angle of 82 Degrees

Tissue sample was prepared as the Example 1 except that the LL-19 was subjected to refining with about 3.0 HPD/T energy input.

### EXAMPLE 4

### Highly Refined Fibers Creping Pocket Angle of 82 Degrees

Tissue sample was prepared as the Example 1 except that the LL-19 was subjected to refining with 6.0 HPD/T energy input.

### EXAMPLE 5

### Moderately Refined Fibers Creping Pocket Angle of 75 Degrees

Tissue sample was prepared as the Example 1 except that the LL-19 was subjected to refining with about 3.0 HPD/T energy input and pocket creping angle of about 75 degrees.

### EXAMPLE 6

### Highly Refined Fibers Creping Pocket Angle of 75 Degrees

Tissue sample was prepared as in Example 1 except that the LL-19 was subjected to refining with 6.0 HPD/T energy input and pocket creping angle is 75 degrees.

TABLE 1

| | Horsepower | | | | |
|---|---|---|---|---|---|
| | Days Per | | | | |
| | Metric Ton | | Geometric | | |
| | of Dry Fiber | | Mean | | |
| | (HPD/T) on | | Tensile | | |
| | LL-19 | Creping | Strength | | |
| | product | Angle | (GMT) | Slough | Softness |
| Example 1 | 0 | 82 | 660 | 12.5 | 8.26 |
| Unrefined | | | | | |
| Example 2 | 1.5 | 82 | 629 | 13.2 | 8.31 |
| Refined | | | | | |
| Example 3 | 3 | 82 | 639 | 12.4 | 8.21 |
| Refined | | | | | |
| Example 4 | 6 | 82 | 708 | 9.7 | 8.08 |
| Refined | | | | | |
| Example 5 | 3 | 75 | 658 | 11.23 | 8.33 |
| Refined | | | | | |
| Example 6 | 6 | 75 | 669 | 10.27 | 8.22 |
| Refined | | | | | |

No data has been accumulated for the following Examples 7-12.

### EXAMPLE 7

### Slightly Refined Fibers Creping Pocket Angle of 80 Degrees

Tissue sample was prepared as in Example 1 except that the creping pocket angle is 80 degrees, and the LL-19 fiber fraction was subjected to refining with about 1.5 horsepower days per metric ton of dry fiber (HPD/T) energy input employed.

### EXAMPLE 8

### Moderately Refined Fibers Creping Pocket Angle of 80 Degrees

Tissue sample was prepared as the Example 7 (angle of 80 degrees) except that the LL-19 was subjected to refining with about 3.0 HPD/T energy input.

### EXAMPLE 9

### Highly Refined Fibers Creping Pocket Angle of 80 Degrees

Tissue sample was prepared as the Example 7 (angle of 80 degrees) except that the LL-19 was subjected to refining with 6.0 HPD/T energy input.

### EXAMPLE 10

### Slightly Refined Fibers Creping Pocket Angle of 78 Degrees

Tissue sample was prepared as the Example 1 except that the creping pocket angle was 78 degrees, and the LL-19 was subjected to refining with about 1.5 HPD/T energy.

### EXAMPLE 11

### Moderately Refined Fibers Creping Pocket Angle of 78 Degrees

Tissue sample was prepared as in Example 10 except that the LL-19 was subjected to refining with about 3.0 HPD/T energy.

### EXAMPLE 12

### Highly Refined Fibers Creping Pocket Angle of 78 Degrees

Tissue sample was prepared as in Example 10 except that the LL-19 was subjected to refining with about 6.0 HPD/T energy.

When comparing Example 1 with Examples 2-4 it can be seen that employing refined fibers having an increasing amount of refinement, at a given creping angle, tends to decrease the amount of tissue slough that is observed. This decreased slough coincides with only a relatively minor loss in softness.

Furthermore, comparing Examples 5 and 6 with Examples 3 and 4, respectively, shows that using refined fibers in combination with a 75 degree closed pocket creping angle produces a paper product having, in general, better slough and softness properties.

Refining may reduce slough from paper products, even though softness also may be adversely affected. Closed pocket creping at less than about 82 degrees combined with refined softwood tends to produce a softer tissue with less slough.

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

What is claimed is:

1. A method of manufacturing a paper product comprising the following steps:
(a) providing at least one papermaking furnish containing fibers;
(b) depositing the furnish upon a drying surface to form a paper web;
(c) contacting the drying surface with a creping blade, the creping blade being held against the drying surface at an angle of less than about 82 degrees; and
(d) removing the paper web from the drying surface.

2. The method of claim 1 in which the papermaking furnish comprises refined fibers.

3. The method of claim 1 additionally comprising the step of:
(e) mating the paper web with another paper web to form a multi-layered paper product.

4. The method of claim 2 in which fibers refined with at least about 1.5 horsepower days per metric ton are employed.

5. The method of claim 2 in which fibers refined with at least about 3.0 horsepower days per metric ton are employed.

6. The method of claim 2 in which fibers refined with at least about 6.0 horsepower days per metric ton are employed.

7. The method of claim 1 in which the creping blade angle is less than about 80 degrees.

8. The method of claim 1 in which the creping blade angle is less than about 78 degrees.

9. The method of claim 1 in which the creping blade angle is less than about 75 degrees.

10. The method of claim 1 in which the creping blade angle is about 75 degrees.

11. A method of manufacturing a paper product using refined fibers, the method comprising:
(a) providing at least one papermaking furnish comprising refined fibers;
(b) depositing the papermaking furnish upon a drying surface to form a paper web;
(c) contacting the drying surface with a creping blade, the creping blade being held against the drying surface at an angle of less than about 82 degrees; and
(d) removing the paper web from the drying surface.

12. The method of claim 11 in which fibers refined with at least about 1.5 horsepower days per metric ton are employed.

13. The method of claim 11 in which fibers refined with at least about 3.0 horsepower days per metric ton are employed.

14. The method of claim 11 in which fibers refined with at least about 6.0 horsepower days per metric ton are employed.

15. The method of claim 11 in which the creping blade angle is less than about 80 degrees.

16. The method of claim 11 in which the creping blade angle is less than about 78 degrees.

17. The method of claim 11 in which the creping blade angle is about 75 degrees or less.

18. The method of claim 11 in which the creping blade angle is about 75 degrees.

19. A paper product formed by the process of:
(a) providing at least one papermaking furnish comprising refined fibers;
(b) depositing the papermaking furnish upon a drying surface to form a paper web;
(c) contacting the drying surface with a creping blade, the creping blade being held against the drying surface at an angle of less than about 82 degrees; and
(d) removing the paper web from the drying surface.

20. The product of claim 19 in which fibers refined with at least about 1.5 horsepower days per metric ton are employed.

21. The product of claim 19 in which fibers refined with at least about 3 horsepower days per metric ton are employed.

22. The product of claim 19 in which fibers refined with at least about 6 horsepower days per metric ton are employed.

23. The product of claim 19 in which the creping blade angle is less than about 80 degrees.

24. The product of claim 19 in which the creping blade angle is less than about 78 degrees.

25. The product of claim 19 in which the creping blade angle is about 75 degrees or less.

26. The product of claim 19 in which the creping blade angle is about 75 degrees.

27. The product of claim 20 in which the creping blade angle is less than about 80 degrees.

28. The product of claim 20 in which the creping blade angle is less than about 78 degrees.

29. The product of claim 20 in which the creping blade angle is about 75 degrees or less.

30. The product of claim 20 in which the creping blade angle is about 75 degrees.
